(19) United States
(12) Patent Application Publication
(10) Pub. No.: US 2008/0155902 A1
(43) Pub. Date: Jul. 3, 2008

(54) INTEGRATED POLYCARBONATE WINDOW ASSEMBLY

(76) Inventor: Clemens Kaiser, Ann Arbor, MI (US)

Correspondence Address: EXATEC;C/O BRINKS HOFER GILSON & LIONE, P. O. BOX 10395, CHICAGO, IL, 60610, US

(21) Appl. No.: 11/964,838

(22) Filed: Dec. 27, 2007

Related U.S. Application Data
(60) Provisional application No. 60/882,357, filed on Dec. 28, 2006.

(51) Int. Cl. E05F 15/08; B60J 7/04

(52) U.S. Cl. 49/349; 296/216.04

(57) ABSTRACT

An integrated plastic window assembly for an automotive vehicle having molded-in functional features includes molded-in guide members to guide a movable panel within or across a plastic fixed panel. In one embodiment adapted to an automotive backlite, a movable panel slidably resides in guide members molded in the lateral edges of a fixed panel. In another embodiment adapted to a sunroof, the window assembly includes a fixed panel molded with a frame having molded-in guide members in which a movable panel slidably resides.

### RELATED APPLICATION

This application claims priority to provisional application 60/882,357, filed Dec. 28, 2006.

### BACKGROUND OF THE INVENTION

This invention concerns polycarbonate window assemblies, particularly for automotive window applications.

It has long been proposed to construct window for automotive vehicles from synthetic resins, i.e., from plastic material such as polycarbonate and polymethylmethyacrylate. Molded plastic automotive windows offer a number of advantages over conventional glass glazing, including improved vehicle safety. Polycarbonate panels better resist shattering as compared to glass and, in a crash, are better than existing glass windows in keeping occupants contained within the vehicle. In that windows are on the upper half of the vehicle, switching to plastic windows will also facilitate a lower center of gravity for the vehicle, contributing to better vehicle handling and safety. Further, plastic windows afford greater design freedom due to the ease in forming complex curved shapes and allow the automotive manufacturer to integrate functional components such as lighting, lighting lenses and light fixture mounts into a window assembly, thereby further reducing weight, materials, and assembly costs. Further because of their lighter weight, plastic materials enable higher fuel efficiencies.

Automotive vehicle manufacturers may install movable window panels not only for side windows but also for all or a portion of the backlite (rear window) and sunroofs. Although glass is commonly used for such applications, using glass as a movable panel requires additional hardware and manufacturing steps. For example, a glass movable panel as part of a backlite in a pickup truck requires fabrication and installation of panel guides, latches, and seals. Moreover, when a movable glass panel is installed in conjunction with a fixed glass panel, the inherent properties of glass and required hardware impose design constraints on the manufacturer, including constraints on the design of junctures and seals between the movable panel and fixed panel. Similarly, although it is common to use glass as part of a sunroof assembly in an automotive vehicle, the inherent properties of glass require installation and assembly of additional hardware, including panel guides, increasing manufacturing costs.

It would be useful to have a lightweight window system, capable of being formed in highly varied shapes, that incorporates molded-in guide members to guide the movement of movable panels without requiring fabrication and installation of additional hardware. It would also be useful if such a window system permitted the design of aesthetically pleasing lighting assemblies, including lighting lenses seamlessly integrated into automotive backlites, particularly in conjunction with modern light-emitting diode (LED) systems.

### SUMMARY OF THE INVENTION

The present invention is an integrated polycarbonate window assembly with molded-in functional features, particularly including an assembly with molded-in guide members to guide a movable panel within or across a polycarbonate fixed panel. In one embodiment, the present invention comprises an automotive backlite having a movable polycarbonate panel within a fixed polycarbonate panel, whereby the movable panel slidably resides in guide members molded in the polycarbonate fixed panel. In another embodiment, the window assembly is adapted for use as a sunroof where the fixed polycarbonate panel has a molded frame with molded-in guide members in which a movable polycarbonate panel slidably resides, such that the movable panel can be moved from an open to closed position along the molded in guide members. In yet another embodiment, the present invention includes a polycarbonate fixed panel with molded-in guide members along which an opaque retractable sunshade can extend to cover the interior surface of the fixed polycarbonate panel.

Other features and advantages of the invention will be apparent from the following description and the following drawings.

### BRIEF DESCRIPTION OF THE DRAWINGS

The accompanying drawings incorporated in and forming a part of the specification illustrate several aspects of the present invention and together with the description serve to explain the principals of the invention. In the drawings:

FIG. 1 is an exterior perspective of a backlite window assembly;

FIG. 2 is an interior perspective of the same backlite window assembly;

FIG. 3A is a sectional drawing of the backlite window assembly showing an interior LED bar light;

FIG. 3B is a sectional drawing of the backlite window assembly showing a fixed polycarbonate panel integrated with a lens covering a center high mount stop light (CHMSL);

FIG. 3C is a sectional drawing of the backlite window assembly showing a fixed polycarbonate panel integrated with a mount for a bulb-type CHMSL;

FIG. 4 is a cross section of the polycarbonate window assembly showing details of alternative joint configurations between the movable and fixed panels;

FIG. 5 is a perspective drawing of a first embodiment of the sunroof incorporating the invention;

FIG. 6 is a cross section of the first embodiment of the sunroof;

FIG. 7 is a longitudinal cross section showing front and rear detail of a second embodiment of a sunroof incorporating the invention; and

FIG. 8 is a lateral cross section showing side detail of the second sunroof embodiment.

### DETAILED DESCRIPTION OF THE INVENTION

The following description of the preferred embodiments is merely exemplary in nature and is in no way intended to limit the invention or its application or uses.

The present invention provides a detailed specification of a plastic, preferably polycarbonate, window assembly in which a fixed polycarbonate panel has molded-in guide members along which a movable panel can be slidably inserted. One embodiment of the invention includes an automotive backlite where the lateral edges of a polycarbonate movable panel slide along guide members formed and molded into lateral interior edges of a polycarbonate fixed panel. This design allows for a substantially flush joint between the movable panel and the fixed panel, as well as the reduction or elimination of several hardware components commonly required for glass window assemblies. A second embodiment includes a sunroof assembly where the fixed polycarbonate panel is molded together with a polycarbonate frame which has guide members molded therein and along which a movable panel can be inserted. This movable panel could be another polycarbonate panel. Alternatively, the movable panel could be a retractable opaque sunshade which moves along the guide members and when fully extended across the fixed polycarbonate panel shields the occupants from the sun.

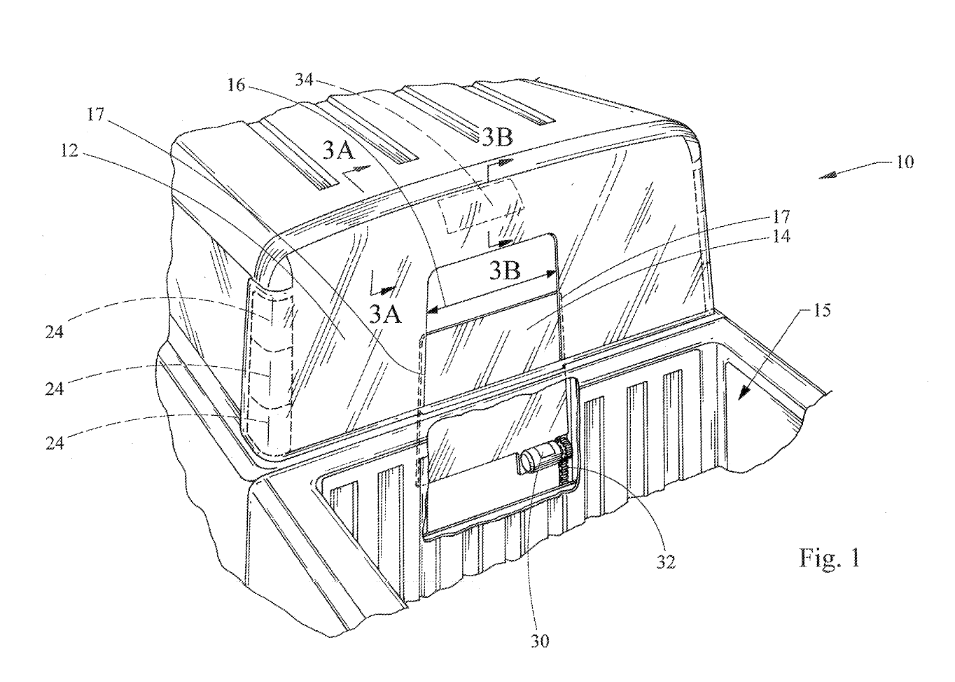

Turning to the drawings, FIG. 1 is an exterior perspective of an automotive backlite window assembly 10, in this case a backlite installed in a pickup truck vehicle. Backlite 10 is comprised primarily of a movable panel 14 slidably installed within an interior portion of fixed panel 12. In the embodiment shown, removable panel 14 slides vertically within fixed panel 12 permitting the occupants of the vehicle to access the rear cargo area 15 through the fixed panel 12. While not required for the present invention, FIG. 1 shows fixed panel 12 extending across the vehicle, across and around side lights 24 and continuing around and along the lateral sides of the vehicle. Such curvature can be difficult to achieve cost effectively with glass. FIG. 1 further shows fixed panel 12 including and extending across a center high mount stop light (CHMSL) 34 in similar fashion.

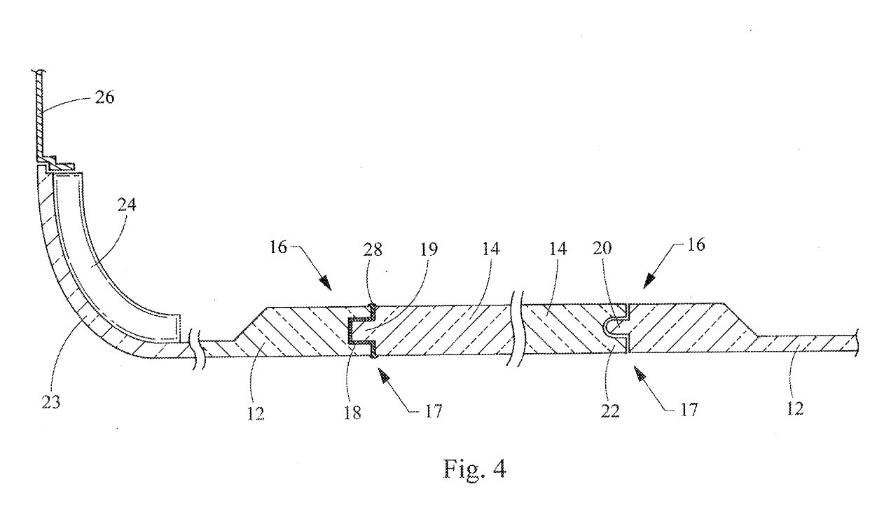

Referring now to FIG. 4, in this figure is shown a cross section of two embodiments of the juncture between movable panel 14 and fixed panel 12. Movable panel 14 has two substantially parallel side edges designed to engage guide members 16. Movable panel 14 slides along guide members 16 that are molded into the opposing lateral edges of an interior portion of the fixed panel 12. The juncture between movable panel 14 and fixed panel 12 thus forms a joint. In the embodiment shown, the exterior joint 17 between movable panel 14 and fixed panel 12 is substantially flush.

There are a number of ways that guide members 16 could be constructed to permit slidable receipt of movable panel 14 within fixed panel 12. The guide members 16 could be constructed as a tongue and groove joint, whereby the lateral interior edge of fixed panel 12 is molded to form a groove 18 into which a corresponding tongue 19, molded along the lateral edge of movable panel 14, slidably inserts permitting translational movement of movable panel 14 within fixed panel 12. In another embodiment this construction is reversed. As shown on the right side of FIG. 4, a tongue 20 is molded into the interior lateral edge of fixed panel 12 onto which movable panel 14 travels along a groove 22 molded into the lateral edge of movable panel 14. Optionally, a non-polycarbonate seal 28 could be installed along the lateral edge of movable panel 14 or fixed panel 12 such that when movable panel 14 is fully inserted into fixed panel 12, the interior of the automotive vehicle is better protected against conditions on the exterior of the vehicle.

The cross section of FIG. 4 also illustrates a preferred embodiment where fixed panel 12 includes an integrated lens portion 23 covering one or more LED sidelights 24. Such sidelight lighting could include tail lights, brake lights, turn signals, back-up lights, or non-illuminating reflectors. In the embodiment shown in FIG. 4, fixed panel 12 extends across the rear of the vehicle, across and around the rear lighting section and extends forward to longitudinal body panel 26. Multiple curves or angles could be molded anywhere into fixed panel 12 near or along any edge thereby permitting novel integration of functional features and aesthetically pleasing backlite design.

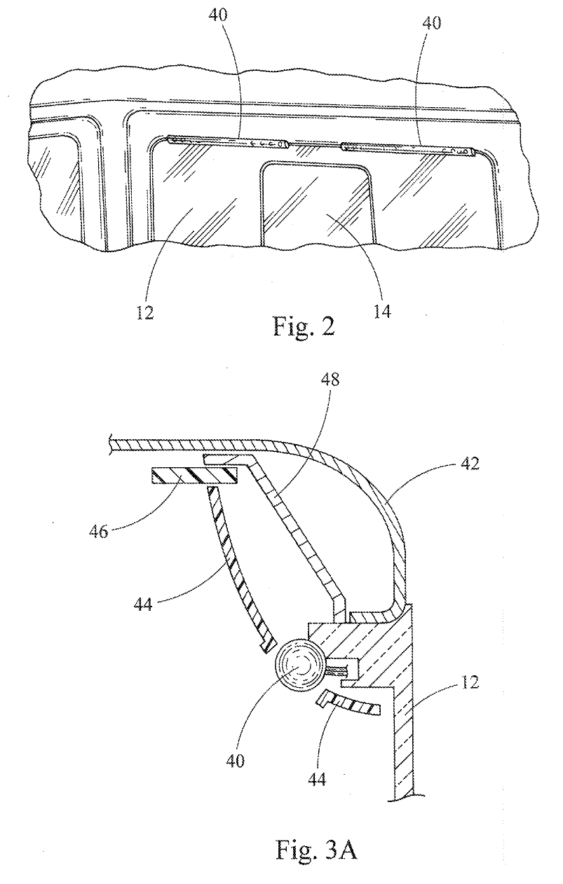

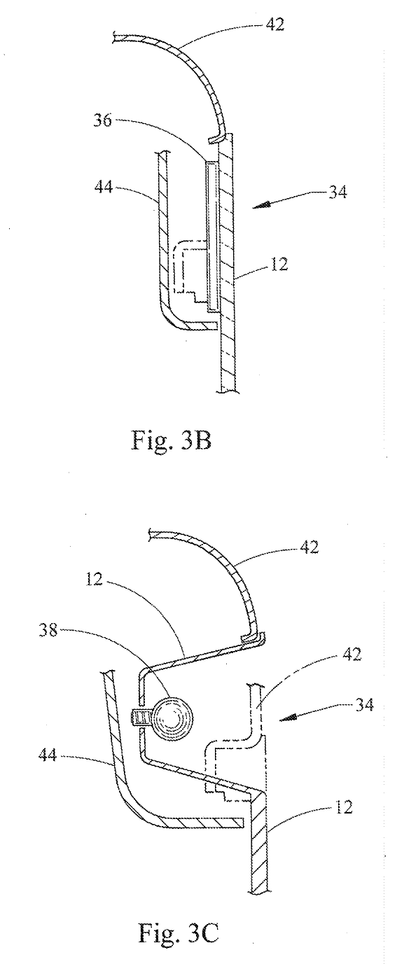

FIG. 2 is an interior perspective of the same backlite assembly shown in FIGS. 1 and 4, showing an LED bar light 40 installed near the top of fixed panel 12 for illuminating the interior of a vehicle. FIG. 3A is a cross section of fixed panel 12 and LED bar light 40 showing how an LED mount and cord receptacle can be molded into fixed panel 12. The flexibility allowed by the polycarbonate molding process could even permit the bar light lens itself to be molded as part of fixed panel 12. FIG. 3A also illustrates a proposed embodiment of the interaction between fixed panel 12, roof panel 42, trim panel 44, roof trim panel 46, and metal roof reinforcement 48.

The center high mount stop light (CHMSL) 34 shown in FIG. 1 is also preferably integrated into fixed panel 12. In one preferred embodiment shown in FIG. 3B, fixed panel 12 extends smoothly across LED CHMSL 36 on the exterior, forming the protective lens for LED CHMSL 36. In an alternative embodiment shown in FIG. 3C, fixed panel 12 is molded to form a light bulb receptacle to accommodate a light bulb CHMSL 38. In this embodiment, a CHMSL lens (not shown) would be appropriately installed to protect light bulb CHMSL 38.

Returning back to FIG. 1, one embodiment of the invention includes a direct drive motor 30 attached to movable panel 14. A gear sprocket or similar engagement mechanism is driven by motor 30 and engages gear channel or rack 32, which is molded into an extended portion of fixed panel 12. Drive motor 30 is operatively connected to gear channel 32 such that when motor 30 is operated, the lateral edges of movable panel 14 are caused to slide along the guide members 16 of fixed panel 12, thereby allowing opening and closing of movable panel 14 within fixed panel 12. In this embodiment, the engagement mechanism is a gear and gear track connected to a direct drive motor. Those skilled in the art will appreciate that there are a variety of engagement mechanisms and drive mechanisms that could be readily substituted for these embodiments without changing the spirit of the invention.

Those skilled in the art will appreciate that fixed panel 12 could be molded to accommodate a variety of guide members for movable panels, lenses for lighting, recesses for lighting assemblies, and other molded-in components to enhance aesthetic design, improve functionality, and reduce assembly costs. Movable panel 14 could represent a relatively small surface area relative to fixed panel 12, or movable panel 14 could have a much larger surface area than fixed panel 12. Those skilled in the art will appreciate that the embodiments depicted in the accompanying figures and described in the specification are merely representative of the many designs made possible by integrating formerly separate functional components within a polycarbonate window molding.

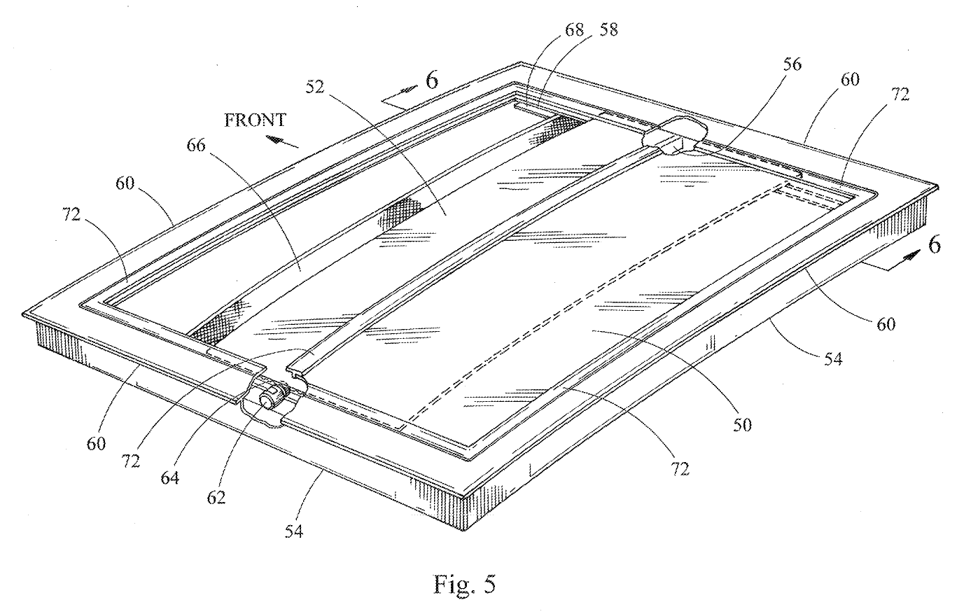

The invention could be embodied in other window applications, including a sunroof/moonroof in an automotive vehicle. A first embodiment of such a sunroof is shown from a top perspective in FIG. 5. This embodiment shows a fixed sunroof panel 50 and movable sunroof panel 52 surrounded by a sunroof frame 54 and separated by a bridge 56. Fixed panel 50 is molded together with a polycarbonate frame 54 having guide members 58 molded along the length therein. Movable sunroof panel 52 is supported by and travels along guide members 58, between the frame 54 and guide members 58 such that movable panel 52 slides under fixed panel 50 when the sunroof is open. In one embodiment, sunroof frame 54 is molded with support brackets 60 molded into at least a portion of sunroof frame 54 to support the sunroof in the vehicle.

FIG. 5 further shows a direct drive motor 62 attached to sunroof frame 54 near bridge 56. In this embodiment, a gear track or channel 64 is molded into movable panel 52 along the side thereof. A gear sprocket or similar engagement mechanism is attached to the output of direct drive motor 62 to engage gear channel 64, thereby causing movable panel 52 to translate along guide members 58 when the motor is operated between open and closed position.

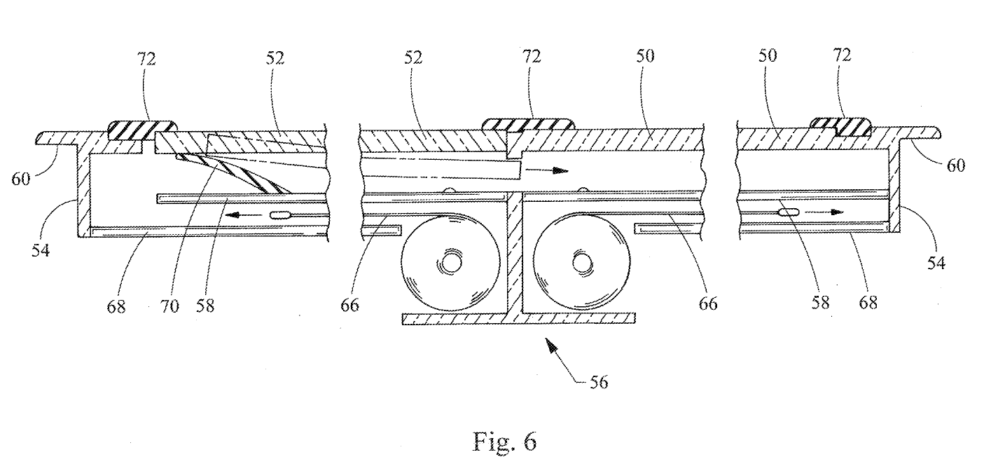

FIG. 6 further illustrates a cross section of the sunroof assembly of FIG. 5 showing sunroof bridge 56 housing retractable opaque sunshades 66. Sunshades 66 are installed within the bridge 56, transverse frame 54 widthwise and may be located in the center of the sunroof or elsewhere along the length of the sunroof. Sunshades 66 are illustrated as wound roller shades that are retractable within the bridge structure 56 using techniques such as internal torsion springs or other designs well known in the art to assure reliable retraction and extraction of sunshade 66. The edges of sunshade 66 travel along and within sunshade guide members 68 also unitarily molded with sunroof frame 54. In the embodiment shown, sunshade guide members 68 are spaced apart from guide members 58 which guide translational movement of movable panel 52. Obviously, the sunshades 66 could be manually, electrically or mechanically operable between their retracted and extracted positions.

FIG. 6 further shows a ramp 70 attached to guide member 58 and frame 54 near a forward edge of frame 54. The assembly is designed so that as movable panel 52 is moved rearward by operation of motor 62 engaging gear channel 64, the rearward edge of movable panel 52 drops below the fixed panel 50. Various structures could be used to facilitate this movement of the rearward edge, including additional ramp structures similar to that discussed below. With rearward movement of the movable panel 52, the forward edge of movable panel 52 then slides down ramp 70 as movable panel 52 travels rearward underneath fixed panel 50 along guide members 58 located on both sides of frame 54. When motor 62 is reversed, movable panel 52 translates forward, with its leading edge moving up ramp 70 and its trailing edge similarly rising to form a relatively smooth juncture sealing movable panel 52 into frame 54. In an optional configuration (not shown), the leading or trailing edge of movable panel 52 could be designed to enable it to rise above the plane defined by fixed panel 50, so as to create an air vent for vehicle occupants. Various well known techniques currently employed with sunroofs could be utilized to so raise the trailing edge of movable panel 52.

Seals 72 are mounted on frame 54 around the forward and side edges of frame 54 where movable panel 52 rests in its closed position. In the preferred embodiment, fixed panel 50 would be integrally and continuously molded with frame 54 thereby eliminating any need for a seal where frame 54 meets fixed panel 50. However, if desired for aesthetic reasons, seal 72 could be extended around the perimeter of fixed panel 50 where fixed panel 50 meets frame 54.

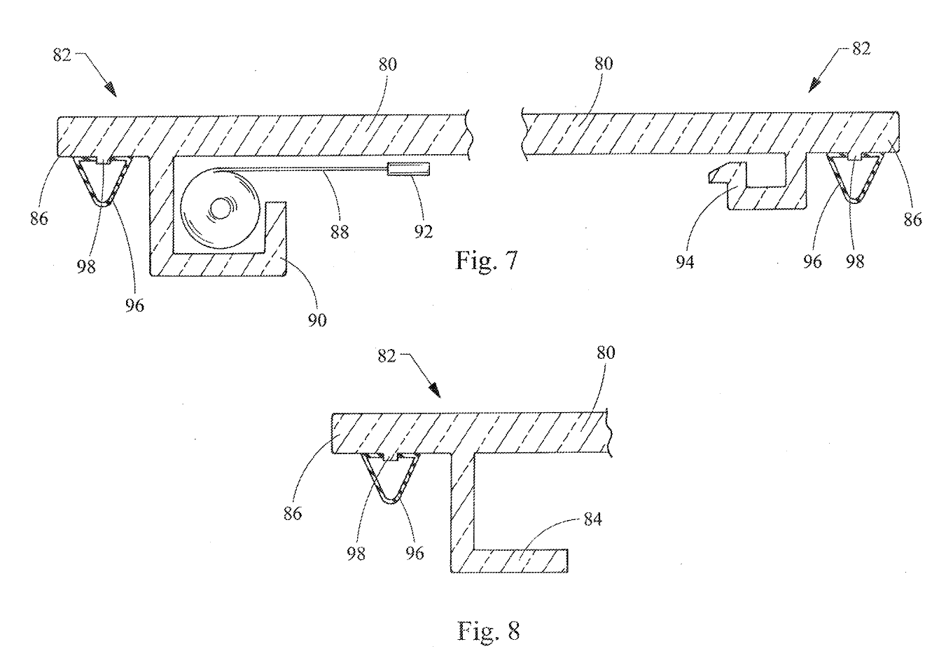

Another embodiment of the invention, also a sunroof, is shown in cross sections in FIGS. 7 and 8. In this embodiment, fixed panel 80 is a one-piece polycarbonate panel having a molded-in frame 82 surrounding the perimeter of fixed panel 80. Within frame 82 are guide members 84 molded into at least two sides of frame 82, preferably into the two lateral (left and right) sides of frame 82. Also molded within frame 82 are support brackets 86 structured to support the sunroof frame 82 in the vehicle. As shown in FIGS. 7 and 8, a movable panel, in this case a retractable sunshade 88, is installed at the rearward edge of frame 82. This movable panel slides along guide members 84 within the interior of the vehicle thereby shielding the occupants from the sun. In the embodiment shown, movable panel 88 (the retractable sunshade) is housed at the rear of frame 82 in a sunshade housing 90. The sunshade has a sunshade latch receptacle 92 which latches at the forward edge of frame 82 using a sunshade latch 94 molded into the forward edge of frame 82. Movable panel 88 (the retractable opaque sunshade) would preferably be wound into a cylinder, similar to a roller shade, spanning the rear edge of frame 82, which cylinder would have an internal torsion spring or other mechanism to assure smooth extraction and retraction of movable panel 88 along guide members 84.

FIGS. 7 and 8 also show a preferred system of aligning and sealing a polycarbonate window assembly into an automotive vehicle. Near the perimeter of frame 82 is a seal 96 surrounding the assembly which helps seal the window assembly against the body of the vehicle. Integrated into fixed panel 80 are molded-in seal seats 98 which receive and secure the non-polycarbonate seal 96. The invention thus reduces or eliminates the need for cement or seal locators commonly employed in glass sunroof assemblies.

While the above description constitutes the preferred embodiments of the present invention, it will be appreciated that the invention is susceptible to modification, variation and change without departing from the proper scope and fair meaning of the accompanying claims.

I claim:

1. A window assembly for an automotive vehicle comprising:
a plastic fixed panel having guide members integrally molded therein and defining an opening; and
a moveable plastic panel movable between a position within the opening and a position at least partially removed from the opening, the movable panel having lateral edges slidably received within the guide members.

2. The window assembly of claim 1 where the guide members are generally located along lateral edges of at least part of the fixed panel, the lateral edges of the moveable panel being matingly received within guide members.

3. The window assembly of claim 2 where the lateral edges and guide members comprise a tongue and groove joint.

4. The window assembly of claim 1 wherein when the moveable panel is within the opening the movable panel is substantially flush with the fixed panel.

5. The window assembly of claim 1 where the window assembly is a backlite.

6. The window assembly of claim 1 further comprising a drive motor attached to the moveable panel and operatively connected to the fixed panel.

7. The window assembly of claim 6 wherein the operative connection comprises a gear track molded in the fixed panel.

8. The window assembly of claim 1 where the fixed panel further comprises a lighting lens molded therein.

9. The window assembly of claim 1 where the fixed panel further comprises a light mounting fixture molded therein.

10. The window assembly of claim 1 where the fixed panel comprises an integrally molded mount for a light fixture on the assembly's interior surface.

11. The window assembly of claim 1 where the window assembly is a sunroof.

12. The window assembly of claim 11 further comprising:
a frame molded as part of the fixed panel, the frame incorporating the guide members along at least two of its sides; and
support brackets integrally molded into the frame to support the sunroof in the vehicle.

13. The window assembly of claim 12 further comprising at least one sunshade mounted to the frame.

14. The window assembly of claim 13 further comprising a sunshade guide channel molded into the frame, portions of the sunshade being received within the sunshade guide channel.

15. The window assembly of claim 14 further comprising a bridge spanning the width of the frame, the sunshade being mounted within the bridge.

16. The window assembly of claim 1 further comprising an integrally molded-in weather seal locator.
